(19) United States
(12) Patent Application Publication
(10) Pub. No.: US 2014/0245053 A1
(43) Pub. Date: Aug. 28, 2014

(54) DISTRIBUTED COMPUTER SYSTEM

(71) Applicants: Takashi Yoshikawa, Minato-ku (JP); Youichi Hidaka, Minato-ku (JP); Jun Suzuki, Minato-ku (JP); Junichi Higuchi, Minato-ku (JP)

(72) Inventors: Takashi Yoshikawa, Minato-ku (JP); Youichi Hidaka, Minato-ku (JP); Jun Suzuki, Minato-ku (JP); Junichi Higuchi, Minato-ku (JP)

(73) Assignee: NEC CORPORATION, Tokyo (JP)

(21) Appl. No.: 14/347,489

(22) PCT Filed: Jun. 13, 2012
(86) PCT No.: PCT/JP2012/065108

§ 371 Date: Mar. 26, 2014

(30) Foreign Application Priority Data
Sep. 27, 2011 (JP) 2011-210483

(51) Int. Cl. G06F 1/32

(52) U.S. Cl. CPC G06F 1/3253
USPC 713/324

(57) ABSTRACT

A local computer (20) and a remote I/O device (30) are interconnected on a network (40) through an upstream side bridge (21) and a downstream side bridge (31). The upstream side bridge (21) and the downstream side bridge (31) each include a register (216, 316) for referring to or writing a signal aside from a primary data stream that runs through the network (40) from both sides, and a mechanism (217, 317) for transmitting and receiving the signal aside from the primary data stream inband when referring to or writing the signal in the register (216, 316).

### BACKGROUND

The present invention relates to a distributed computer system in which a local computer and a remote I/O device are disposed so as to be distributed on a network.

FIG. 3 is a functional block diagram illustrating a configuration of a standard PCI Express switch 60 according to a conventional example. The PCI Express switch 60 includes an upstream side bridge 61 that terminates the upstream side (root side) and stores data transmitted from the upstream side into an upstream side data buffer 62 and stores a control signal pertaining to control in logical processing aside from a data path into an upstream side register 63. Similarly, at a downstream side (endpoint side), the PCI Express switch 60 includes a downstream side bridge 64, and a downstream side data buffer 65 and a downstream side register 66 transmit data to the downstream side.

Proposed in Non-Patent Documents 1 and 2 is a system serving as a computer system for expanding a function of the PCI Express, in which a local computer (a motherboard that includes a CPU, a memory, a chip set, and so on) and a remote I/O device are disposed so as to be distributed on a network and a virtual PCI Express switch is constructed on the Ethernet. In this computer system, an operation and a function that are equivalent to those of the standard PCI Express switch 60 according to the conventional example illustrated in FIG. 3 are realized by integrating an upstream side bridge that is connected to the local computer, a downstream side bridge that is connected to the remote I/O device, and the Ethernet that connects these two bridges. Thus, such a computer system has an advantage in that despite being a distributed computer system, hardware can be configured by using commercially available motherboard and I/O device. The aforementioned computer system has an additional advantage in that commercially available operating system and driver can be used as-is as software. In addition, in regard to a primary data stream that runs between the upstream side bridge and the downstream side bridge, control and data communication of the PCI Express are carried out by using a standard Ethernet packet and loading a TLP (transaction layer packet) of the PCI Express on a payload section of the standard Ethernet packet. Thus, the aforementioned computer system has an advantage in that a commercially available Ethernet switch can be used without requiring any modification. Furthermore, disposing the devices so as to be distributed on the network using this computer system allows the devices to be connected freely, and the system can be expanded without being subject to limitations of distance and limitations of a housing. In addition, by setting a group ID of the remote I/O device such that the group ID of the remote I/O device coincides with a group ID of the local computer, the remote I/O device can be affiliated with the local computer.

Non-Patent Document 1: The Institute of Electronics, Information and Communication Engineers Society Conference 2006, B-6-57 ExpressEther-Ethernet-Based Virtualization Technology for Reconfigurable Hardware Platform:

### (1) System Overview and Architecture

Non-Patent Document 2: The Institute of Electronics, Information and Communication Engineers Society Conference 2006, B-6-58 ExpressEther-Ethernet-Based Virtualization Technology for Reconfigurable Hardware Platform: (2) I/O Virtualization Technology

### SUMMARY

However, the PCI Express switch 60 according to the conventional example illustrated in FIG. 3 uses a common register 67 as a mechanism for reading and writing a specific control signal (e.g., a timing signal for synchronizing processing, a control signal such as conditional branching at each logic circuit, and a signal indicating a state such as a state and a mode) from both the upstream side bridge 61 and the downstream side bridge 64, and is not configured such that this specific control signal is loaded on a TLP and is read and written from both the upstream side bridge 61 and the downstream side bridge 64. Thus, if the functions of the PCI Express switch are disposed so as to be distributed between the upstream side bridge and the downstream side bridge over the network, as proposed in Non-Patent Documents 1 and 2, there arises a problem in that the specific control signal cannot be used.

In addition, as a signal aside from the primary data stream transmitted while being loaded on the TLP, a sideband signal is transmitted and received between the local computer and the remote I/O device, which constitute a PCI Express switch network. The sideband signal includes, for example, a signal that relates to power supply management or management of a hardware state of a card, or specifically, Presence that indicates whether or not a card is present in a slot, SMBus for exchanging management data of the local computer, SMCIk, a JTAG signal (TCK, TDI, TDO, TMS), WAKE# for requesting a power supply to be turned ON, PWRGD indicating that the power supply of the card is on, and so on. These sideband signals are transmitted in the form of High/Low signals of a logic level through a connector of the PCI Express slot and thus could not be transmitted while being loaded on the TLP over the Ethernet.

In addition, disposing the remote I/O device at a distance from the local computer over the network leads to the following inconvenience in terms of power supply management. For example, in a state where the remote I/O device is inserted into the PCI Express slot of the local computer, the power supply of the local computer and the power supply of the remote I/O device are always turned on/off cooperatively. However, in a case where the remote I/O device is connected to the local computer over the network, the power supply of the local computer and the power supply of the remote I/O device are not associated with each other and thus need to be turned on/off independently from each other. In the case where a keyboard, a mouse, a graphic display, and so on are disposed at the remote I/O device side and a motherboard is disposed at the local computer side over the network, although there is such a demand that the power supply of the local computer is controlled to be turned on/off from the remote I/O device side, the two power supplies are not associated with each other, and thus there arises an inconvenience in that the power supply of the local computer cannot be controlled from the remote I/O device side.

Therefore, the present invention is directed to realizing resource management or control, at a hardware level, between the local computer and the remote I/O device that are connected through the network at an level equivalent to that in an environment in which the remote I/O device is connected to the local computer without the network therebetween.

In order to solve the above problem, a distributed computer system according to the present invention includes an upstream side bridge that is connected to a local computer, and a downstream side bridge that is connected to a remote I/O device. The local computer and the remote I/O device are interconnected on the network through the upstream side bridge and the downstream side bridge. The upstream side bridge and the downstream side bridge each include a register for referring to or writing a signal aside from a primary data stream that runs through the network from both sides, and a mechanism for transmitting and receiving the signal aside from the primary data stream inband when referring to or writing the signal in the register.

According to the present invention, resource management or control, at a hardware level, between the local computer and the remote I/O device that are connected through the network can be realized at an level equivalent to that in an environment in which the remote I/O device is connected to the local computer without the network therebetween.

### DESCRIPTION OF DRAWINGS

FIG. 1 is a functional block diagram illustrating a configuration of a distributed computer system according to Embodiment 1;

FIG. 2 is a functional block diagram illustrating a configuration of a distributed computer system according to Embodiment 2; and

FIG. 3 is a functional block diagram illustrating a configuration of a PCI Express switch according to a conventional example.

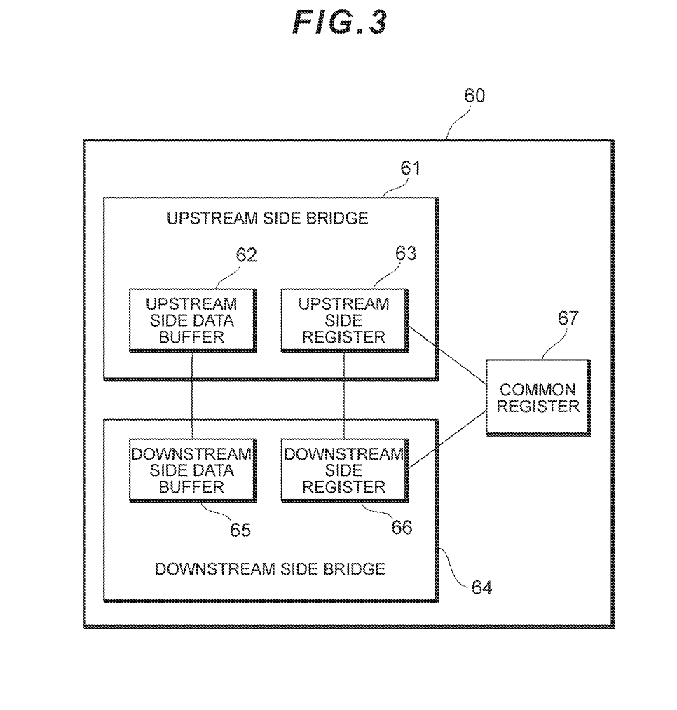

### DETAILED DESCRIPTION

Hereinafter, embodiments of the present invention will be described with reference to the drawings. Identical functional blocks are given identical reference numerals, and duplicate descriptions thereof will be omitted.

### EMBODIMENT 1

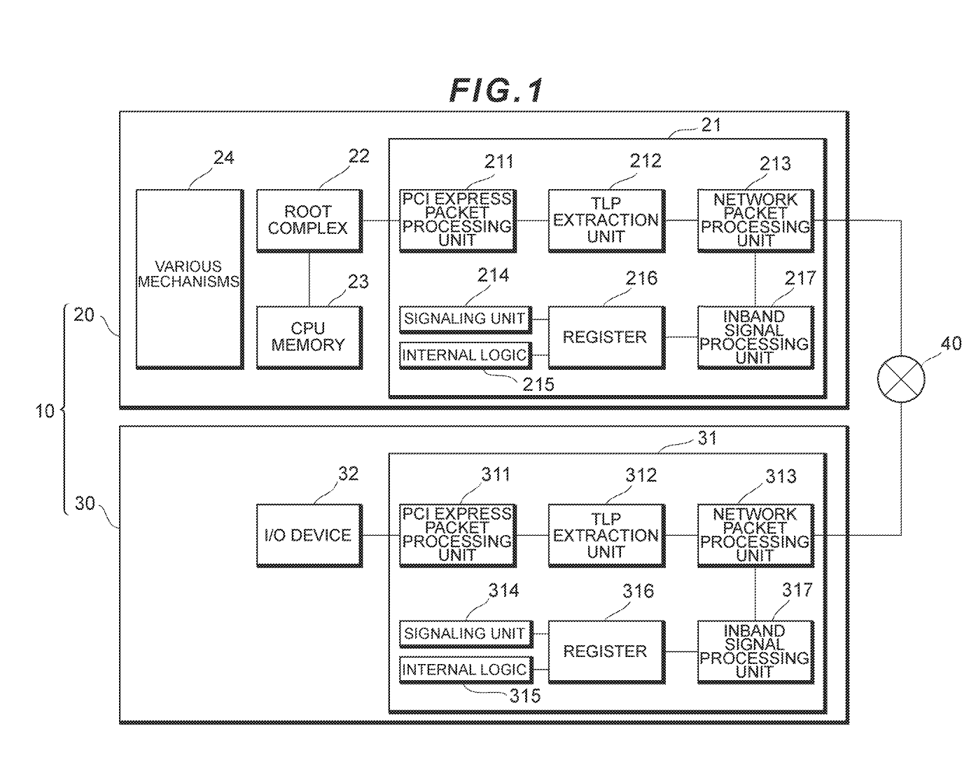

FIG. 1 is a functional block diagram illustrating a configuration of a distributed computer system 10 according to Embodiment 1. The distributed computer system 10 includes an upstream side bridge 21 that is connected to a local computer 20 and a downstream side bridge 31 that is connected to a remote I/O device 30. The local computer 20 and the remote I/O device 30 are interconnected on a network 40 through the upstream side bridge 21 and the downstream side bridge 31. The local computer 20 is, for example, a motherboard and includes, as its constituent components, a CPU and memory 23, a root complex 22 serving as a memory I/O control chip set, and other various mechanisms 24. The various mechanisms 24 include, for example, a power supply, an ATA, a PCI Express slot, a housing, and so on. The remote I/O device 30 includes an I/O device 32. The I/O device 32 is an endpoint capable of PCI Express connection and includes, for example, a graphic interface card, a hard disk controller, a network controller, and so on. If the I/O device 32 is located at the remote side, the I/O device 32 is connected to the downstream side bridge 31, and if the I/O device 32 is located at the local side, the I/O device 32 is connected to the PCI Express slot of the local computer 20. The upstream side bridge 21 and the downstream side bridge 31 each have a function of a conventional PCI Express switch and are each configured to function as a virtual switch in which the aforementioned function is further expanded. Thus, even if the I/O device 32 is located at the remote side, the I/O device 32 can be connected to the root complex 22 in an environment equivalent to that in which the I/O device 32 is connected to the PCI Express slot of the local computer 20. In addition, the I/O device 32 can be used from software, an operating system, and a BIOS that operate on the local computer 20, irrespective of whether the I/O device 32 is located at the remote side or is located at the local side.

Here, transmission of a primary data stream between the upstream side bridge 21 and the downstream side bridge 31 will be described. The upstream side bridge 21 includes, as a mechanism for transmitting and receiving the primary data stream that runs through the network 40 to and from the downstream side bridge 31, a PCI Express packet processing unit 211, a TLP extraction unit 212, and a network packet processing unit 213. Similarly, the downstream side bridge 31 includes, as a mechanism for transmitting and receiving the primary data stream that runs through the network 40 to and from the upstream side bridge 21, a PCI Express packet processing unit 311, a TLP extraction unit 312, and a network packet processing unit 313.

First, flow of the primary data stream from the upstream side to the downstream side will be described. The PCI Express packet processing unit 211 receives from the root complex 22 a PCI Express packet that includes the primary data stream in a payload thereof and terminates a physical layer and a data link layer of the PCI Express packet. The TLP extraction unit 212 extracts from the PCI Express packet a TLP, which is a packet of a transaction layer. The network packet processing unit 213 encapsulates the extracted TLP in a format compliant with a communication protocol of the network 40 and sends out the result to the downstream side bridge 31 through the network 40. The network packet processing unit 313 terminates the network protocol of the received packet. The TLP extraction unit 312 extracts the TLP from the received packet. The PCI Express packet processing unit 311 appends each header of the physical layer and the data link layer of the PCI Express to the extracted TLP to generate a PCI Express packet and sends out the PCI Express packet to the I/O device 32. The PCI Express packet that is to be sent out from the PCI Express packet processing unit 311 to the I/O device 32 is equivalent to the PCI Express packet which the PCI Express packet processing unit 211 receives from the root complex 22.

Subsequently, flow of the primary data stream from the downstream side to the upstream side will be described. The PCI Express packet processing unit 311 receives from the I/O device 32 a PCI Express packet that includes the primary data stream in a payload thereof and terminates a physical layer and a data link layer of the PCI Express packet. The TLP extraction unit 312 extracts from the PCI Express packet a TLP, which is a packet of a transaction layer. The network packet processing unit 313 encapsulates the extracted TLP in a format compliant with a communication protocol of the network 40 and sends out the result to the upstream side bridge 21 through the network 40. The network packet processing unit 213 terminates the network protocol of the received packet. The TLP extraction unit 212 extracts the TLP from the received packet. The PCI Express packet processing unit 211 appends each header of the physical layer and the data link layer of the PCI Express to the extracted TLP to generate a PCI Express packet and sends out the PCI Express packet to the root complex 22. The PCI Express packet that is to be sent out from the PCI Express packet processing unit 211 to the root complex 22 is equivalent to the PCI Express packet which the PCI Express packet processing unit 311 receives from the I/O device 32.

Through the series of operations described above, even if the I/O device 32 is located at the remote side, the I/O device 32 can be connected to the root complex 22 in an environment that is equivalent to that in which the I/O device 32 is connected to the PCI Express slot of the local computer 20. In other words, the above configuration is equivalent to a configuration in which the functions of the conventional PCI Express switch are implemented so as to be distributed between the upstream side bridge 21 and the downstream side bridge 31 through the network 40.

Next, a mechanism for reading and writing a specific control signal between the upstream side bridge 21 and the downstream side bridge 31 through the network 40 will be described. The specific control signal is a signal aside from the primary data stream that runs through the network 40 and includes, for example, a timing signal for synchronizing processing, a control signal for conditional branching or the like at each logic circuit, a signal indicating a state such as a state and a mode, and so on. Specific examples of the specific control signal include Strobe used to synchronize data, Valid indicating validity of the data, State of a state machine pertaining to logical processing, and so on. The upstream side bridge 21 includes, as a mechanism for reading and writing the specific control signal, a signaling unit 214, an internal logic 215, a register 216, and an inband signal processing unit 217. Similarly, the downstream side bridge 31 includes, as a mechanism for reading and writing the specific control signal, a signaling unit 314, an internal logic 315, a register 316, and an inband signal processing unit 317. These registers 216 and 316 are configured to be accessible from both the upstream side bridge 21 and the downstream side bridge 31 and serve to read and write the specific control signal.

First, flow of the specific control signal from the upstream side to the downstream side will be described. The signaling unit 214 overwrites the content (specific control signal) of the register 216, upon the state pertaining to the logical processing and so on of the internal logic 215 being modified or upon receiving a reference request from the downstream side bridge 31. Upon the content of the register 216 being overwritten, the register 216 converts the overwritten signal into a signal format to be transmitted and received through the network 40 in an inband system and transfers the result to the inband signal processing unit 217. The overwritten signal may be transferred to the inband signal processing unit 217 when the register 216 is detected to be overwritten or when it is detected that a flag indicating that there is a signal to be transmitted in the inband system is on. The inband signal processing unit 217 puts the signal to be transferred and a register address into a set to generate an inband signal packet of a size having a packet length equivalent to that of the TLP and transfers the result to the network packet processing unit 213. The network packet processing unit 213 inserts the inband signal packet into the primary data stream from the TLP extraction unit 212, encapsulates the result into a format compliant with a communication protocol of the network 40, and sends out the result to the downstream side bridge 31 through the network 40. The network packet processing unit 313 decapsulates the received capsule; if the payload thereof is a TLP, the network packet processing unit 313 transfers this to the TLP extraction unit 312; and if the payload thereof is an inband signal packet, the network packet processing unit 313 transfers this to the inband signal processing unit 317. The inband signal processing unit 317 restores the signal and the register address from the inband signal packet that has been converted to have a packet length equivalent to that of the TLP and writes the result into the register 316. Upon the content of the register 316 being overwritten, the register 316 notifies the signaling unit 314. The register 316 may notify the signaling unit 314 when the register 316 is detected that its content has been overwritten, or when it is detected that a flag indicating that the register 316 has been overwritten is on.

Next, flow of the specific control signal from the downstream side to the upstream side will be described. The signaling unit 314 overwrites the content (specific control signal) of the register 316, upon the state pertaining to the logical processing and so on of the internal logic 315 being modified or upon receiving a reference request from the upstream side bridge 21. Upon the content of the register 316 being overwritten, the register 316 converts the overwritten signal into a signal format to be transmitted and received through the network 40 in the inband system and transfers the result to the inband signal processing unit 317. The overwritten signal may be transferred to the inband signal processing unit 317 when the register 316 is detected to be overwritten or when it is detected that a flag indicating that there is a signal to be transmitted in the inband system is on. The inband signal processing unit 317 puts the signal to be transferred and a register address into a set to generate an inband signal packet of a size having a packet length equivalent to that of the TLP and transfers the result to the network packet processing unit 313. The network packet processing unit 313 inserts the inband signal packet into the primary data stream from the TLP extraction unit 312, encapsulates the result into a format compliant with a communication protocol of the network 40, and sends out the result to the upstream side bridge 21 through the network 40. The network packet processing unit 213 decapsulates the received capsule; if the payload thereof is a TLP, the network packet processing unit 213 transfers this to the TLP extraction unit 212; and if the payload thereof is an inband signal packet, the network packet processing unit 213 transfers this to the inband signal processing unit 217. The inband signal processing unit 217 restores the signal and the register address from the inband signal packet that has been converted to have a packet length equivalent to that of the TLP and writes the result into the register 216. Upon the content of the register 216 being overwritten, the register 216 notifies the signaling unit 214. The register 216 may notify the signaling unit 214 when the register 216 is detected that its content has been overwritten, or when it is detected that a flag indicating that the register 216 has been overwritten is on.

According to the present embodiment, since the configuration is such that signal conversion and connection are carried out so as to transmit and receive the specific control signal, while being loaded on a TLP, between the upstream side bridge 21 and the downstream side bridge 31 through the network 40 without a conflict so that the processing pertaining to the specific control signal, which has been processed conventionally within a PCI Express switch, can be carried out over the network 40 using commercially available motherboard and I/O device as-is, the operation of the distributed computer system 10 can be further stabilized, and a complex operation is made possible.

### EMBODIMENT 2

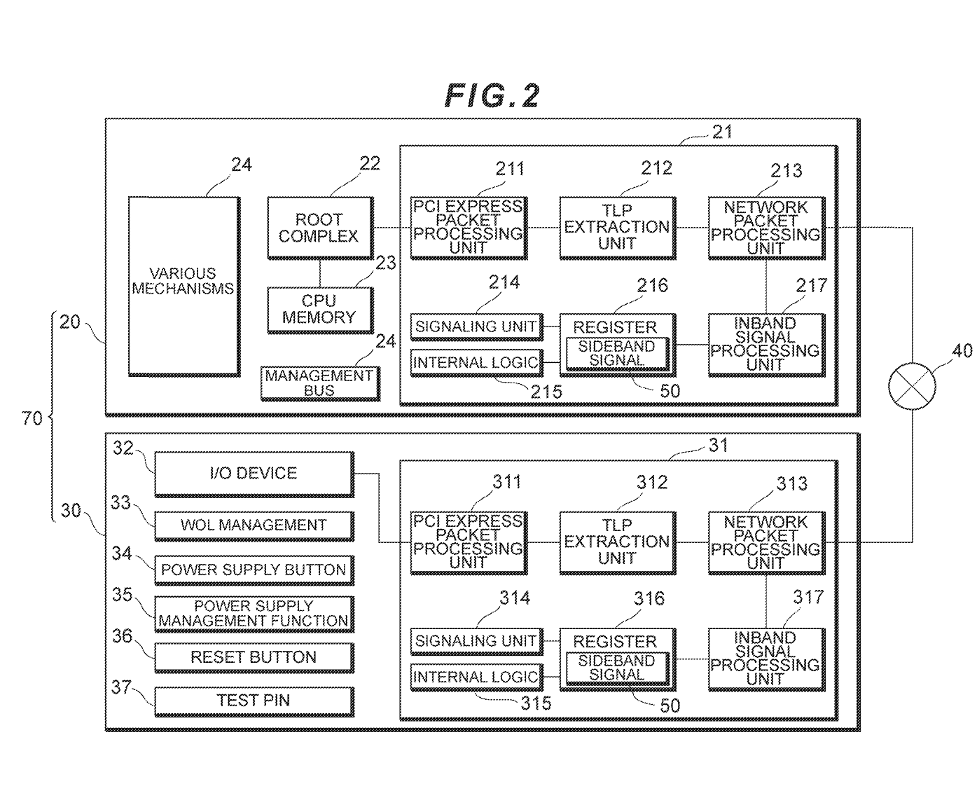

FIG. 2 is a functional block diagram illustrating a configuration of a distributed computer system 70 according to Embodiment 2. In the distributed computer system 70, the function of the distributed computer system 10 according to Embodiment 1 has been further expanded, and the distributed computer system 70 includes a mechanism for transmitting and receiving a sideband signal 50 of the PCI Express standard between the upstream side bridge 21 and the downstream side bridge 31 through the inband system. The sideband signal 50 includes, for example, a signal that relates to power supply management and management of the hardware state of the card, or specifically, Presence that indicates whether or not a card is present in a slot, SMBus for exchanging management data of the local computer, SMCIk, a JTAG signal (TCK, TDI, TDO, TMS), WAKE# for requesting the power supply to be turned ON, PWRGD indicating that the power supply of the card is on, and so on.

It is to be noted that flow of the processing for transmitting and receiving the sideband signal 50 between the upstream side bridge 21 and the downstream side bridge 31 through the inband system is similar to the flow of the processing for transmitting and receiving the specific control signal between the upstream side bridge 21 and the downstream side bridge 31 through the inband system as described in Embodiment 1, and thus detailed description thereof will be omitted.

The remote I/O device 30 includes a Wol (Wake On LAN) management function 33 for controlling on/off of the power supply of the computer over the network, which is a specialized function of NIC in the Ethernet, and a typical power supply management function 35 of the PCI Express standard. Upon detecting an on/off input of a power supply button 34, the signaling unit 314 writes the sideband signal 50 for requesting the power supply to be turned on/off into the register 316. This sideband signal 50 is transmitted to the upstream side bridge 21 from the downstream side bridge 31 through the network 40 and written into the register 216. The signaling unit 214 outputs the sideband signal 50 to a management bus 24 and connects to WAKE# of the PCI Express slot to turn on/off the power supply of the local computer 20. Through this, the power supply of the local computer 20 can be controlled to be turned on/off from the remote I/O device 30 over the network 40.

The remote I/O device 30 includes a reset button 36. Upon detecting an input of the reset button 36, the signaling unit 314 writes the sideband signal 50 for requesting a reset into the register 316. This sideband signal 50 is transmitted to the upstream side bridge 21 from the downstream side bridge 31 through the network 40 and is written into the register 216. The signaling unit 214 outputs the sideband signal 50 to the management bus 24 and connects to PERST# of the PCI Express slot to reset the local computer 20. Through this, the local computer 20 can be reset from the remote I/O device 30 over the network 40.

The remote I/O device 30 includes a test pin (or connector) 37 for inputting a JTAG signal and can also transmit a JTAG signal inputted to the test pin 37 to the management bus 24 of the local computer 20 inband through the downstream side bridge 31 and the upstream side bridge 21.

The description given above is an example in which the sideband signal 50 is transmitted and received inband between the upstream side bridge 21 and the downstream side bridge 31, but the present invention is not limited to the above-described example and includes various modifications that do not depart from the scope and the spirit of the present invention. For example, when the local computer 20 detects a beacon of the PCI Express standard, the local computer 20 may issue a PME (Power Management Event) and transmit a signal requesting the power supply of the remote I/O device 30 to be turned on to the remote I/O device 30 inband through the upstream side bridge 21 and the downstream side bridge 31.

It is to be noted that the distributed computer system 70 according to Embodiment 2 includes configurations that are equivalent to those of the distributed computer system 10 according to Embodiment 1 and thus includes a function that is equivalent to the conventional PCI Express switch and also a function of transmitting and receiving the specific control signal through the inband system as described in Embodiment 1. These functions are similar to those of Embodiment 1, and thus detailed description thereof will be omitted.

According to the present embodiment, by transmitting and receiving a signal between the local computer 20 and the remote I/O device 30 through the inband system, various types of management such as power supply management, resetting, and JTAG testing can be carried out over the network 40, and thus convenience in operation can be improved. In addition, by managing the power supply over the network 40, the power supply is prevented from being turned on when unnecessary, and thus reduction in power consumption can be achieved.

This application claims priority to Japanese Patent Application No. 2011-210483, filed on Sep. 27, 2011, and the entire contents of which are incorporated herein.

Thus far, the present invention has been described with reference to the embodiments, but the present invention is not limited to the embodiments described above. Various modifications can be made and conceived of by a person skilled in the art to the configurations and the details of the present invention within the scope of the present invention.

It is to be noted that part or all of Embodiments 1 and 2 described above can be described as in the following appendices but is/are not limited thereto.

### (Appendix 1)

A distributed computer system includes an upstream side bridge connected to a local computer and a downstream side bridge connected to a remote I/O device, wherein

the local computer and the remote I/O device are interconnected on a network through the upstream side bridge and the downstream side bridge, and the upstream side bridge and the downstream side bridge each include a register for referring to or writing a signal aside from a primary data stream that runs through the network from both sides, and a mechanism for transmitting and receiving the signal aside from the primary data stream inband when referring to or writing the signal in the register.

### (Appendix 2)

The distributed computer system according to Appendix 1, wherein

the signal aside from the primary data stream that runs through the network is a sideband signal of a PCI Express standard.

### (Appendix 3)

The distributed computer system according to Appendix 2, wherein

the remote I/O device includes a power supply button, and upon detecting an on/off input of the power supply button, the remote I/O device transmits the sideband signal requesting a power supply to be turned on/off to the local computer inband through the downstream side bridge and the upstream side bridge, and upon receiving the sideband signal requesting the power supply to be turned on/off, the local computer turns on/off the power supply thereof.

### (Appendix 4)

The distributed computer system according to Appendix 2, wherein

the remote I/O device includes a reset button, and upon detecting an input of the reset button, the remote I/O device transmits the sideband signal requesting a reset to the local computer inband through the downstream side bridge and the upstream side bridge, and

upon receiving the sideband signal requesting the reset, the local computer resets itself.

### (Appendix 5)

The distributed computer system according to Appendix 2, wherein

the remote I/O device includes a test pin for inputting a JTAG signal and transmits a JTAG signal inputted to the test pin to the local computer inband through the downstream side bridge and the upstream side bridge.

### (Appendix 6)

A distributed computer system includes an upstream side bridge connected to a local computer and a downstream side bridge connected to a remote I/O device, wherein

the local computer and the remote I/O device are interconnected on a network through the upstream side bridge and the downstream side bridge,

the upstream side bridge and the downstream side bridge each include a mechanism for transmitting and receiving a signal aside from a primary data stream that runs through the network inband, and

upon detecting a beacon of a PCI Express standard, the local computer issues a PME and transmits a signal requesting a power supply of the remote I/O device to be turned on to the remote I/O device inband through the upstream side bridge and the downstream side bridge.

10 Distributed computer system

20 Local computer

21 Upstream side bridge

22 Root complex

23 CPU and memory

24 Various mechanisms

30 Remote I/O device

31 Downstream side bridge

32 I/O device

33 Wol management function

34 Power supply button

35 Power supply management function

36 Reset button

37 Test pin

50 Sideband signal

60 PCI express switch

61 Upstream side bridge

62 Upstream side data buffer

63 Upstream side register

64 Downstream side bridge

65 Downstream side data buffer

66 Downstream side register

67 Common register

70 Distributed computer system

211 PCI express packet processing unit

212 TLP extraction unit

213 network packet processing unit

214 Signaling unit

215 Internal logic

216 Register

217 Inband signal processing unit

311 PCI express packet processing unit

312 TLP extraction unit

313 Network packet processing unit

314 Signaling unit

315 Internal logic

316 Register

317 Inband signal processing unit

What is claimed is:

1. A distributed computer system, comprising:
an upstream side bridge connected to a local computer; and
a downstream side bridge connected to a remote I/O device,
wherein the local computer and the remote I/O device are interconnected on a network through the upstream side bridge and the downstream side bridge, and
wherein the upstream side bridge and the downstream side bridge each include a register for referring to or writing a signal aside from a primary data stream that runs through the network from both sides, and a mechanism for transmitting and receiving the signal aside from the primary data stream inband when referring to or writing the signal in the register.

2. The distributed computer system according to claim 1, wherein the signal aside from the primary data stream that runs through the network is a sideband signal of a PCI Express standard.

3. The distributed computer system according to claim 2, wherein the remote I/O device includes a power supply button, and upon detecting an on/off input of the power supply button, the remote I/O device transmits the sideband signal requesting a power supply to be turned on/off to the local computer inband through the downstream side bridge and the upstream side bridge, and upon receiving the sideband signal requesting the power supply to be turned on/off, the local computer turns on/off the power supply thereof.

4. The distributed computer system according to claim 2, wherein the remote I/O device includes a reset button, and upon detecting an input of the reset button, the remote I/O device transmits the sideband signal requesting a reset to the local computer inband through the downstream side bridge and the upstream side bridge, and upon receiving the sideband signal requesting the reset, the local computer resets itself.

5. The distributed computer system according to claim 2, wherein the remote I/O device includes a test pin for inputting a JTAG signal and transmits a JTAG signal inputted to the test pin to the local computer inband through the downstream side bridge and the upstream side bridge.

6. A distributed computer system, comprising:
an upstream side bridge connected to a local computer; and
a downstream side bridge connected to a remote I/O device,
wherein the local computer and the remote I/O device are interconnected on a network through the upstream side bridge and the downstream side bridge,
wherein the upstream side bridge and the downstream side bridge each include a mechanism for transmitting and receiving a signal aside from a primary data stream that runs through the network inband, and
wherein upon detecting a beacon of a PCI Express standard, the local computer issues a PME and transmits a signal requesting a power supply of the remote I/O device to be turned on to the remote I/O device inband through the upstream side bridge and the downstream side bridge.
